(19) United States
(12) Patent Application Publication
(10) Pub. No.: US 2008/0136252 A1
(43) Pub. Date: Jun. 12, 2008

(54) FAIL-SAFE SYSTEM FOR BRAKE OF HYBRID ELECTRIC VEHICLE AND METHOD OF CONTROLLING THE SAME

(76) Inventor: Kyu Sang Ro, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/940,479

(22) Filed: Nov. 15, 2007

(30) Foreign Application Priority Data
Dec. 11, 2006 (KR) 10-2006-0125610

(51) Int. Cl. B60T 8/88

(52) U.S. Cl. 303/113.4

(57) ABSTRACT

A fail-safe system for a brake of a hybrid electric vehicle and a method of its use. The system includes: a connection tube for providing fluid communication between an intake system and a brake booster, a vacuum pressure supply element for supplying a negative pressure to the brake booster through the connection tube, a first valve for interrupting the fluid communication between the intake system and the brake booster, and a control unit for determining a brake fail condition. If the brake fail condition is determined, the control unit controls the first valve to interrupt the fluid communication, and controls the vacuum pressure supply element to supply the negative pressure to the brake booster.

### CROSS-REFERENCE TO RELATED APPLICATIONS

This application claims the benefit under 35 U.S.C. §119(a) of Korean Patent Application No. 2006-0125610, filed in the Korean Intellectual Property Office on Dec. 11, 2006, the entire contents of which are incorporated herein by reference.

### BACKGROUND OF THE INVENTION

1. Field of the Invention

The present invention relates to a fail-safe system for a brake of a hybrid electric vehicle and method of controlling the same. More particularly, the present invention relates to a fail-safe system for a brake of a hybrid electric vehicle and method of controlling the same, which can interrupt the supply of atmospheric pressure to a brake booster line from an intake system under a brake fail condition and operate a separate vacuum supply element to create vacuum pressure.

1. Background Art

The term “hybrid vehicle,” in its broadest sense, refers to a vehicle that utilizes at least two different kinds of power sources. Usually, the term refers to a vehicle that uses fuel and an electric motor, driven by a battery. Such a vehicle is more precisely called a hybrid electric vehicle (HEV).

The hybrid electric vehicle can take on many various structures. Most hybrid electric vehicles are either parallel type or series type.

The parallel type hybrid electric vehicle is configured such that the engine charges the battery and also directly drives the vehicle together with the electric motor. Such a parallel type hybrid electric vehicle has a shortcoming in that its structure and control logic are relatively complicated compared to the series type. Nevertheless, since this parallel type hybrid electric vehicle is efficient in that it utilizes the mechanical energy of the engine and the electric energy of the battery simultaneously, it is widely adopted in passenger cars, etc.

A typical hybrid electric vehicle is equipped with a hybrid control unit (HCU) for controlling the overall operation of the vehicle. For example, the HCU includes an engine control unit (ECU), a motor control unit (MCU), a transmission control unit (TCU), a battery management system (BMS), a full auto temperature controller (FATC) for controlling the interior temperature of the vehicle and the like.

These control units are interconnected via a high-speed CAN communication line with the hybrid control unit as an upper controller so that they mutually transmit and receive information.

In addition, the hybrid electric vehicle includes a high voltage battery, or main battery, for supplying the driving power of the electric motor. The high voltage battery supplies a needed power while continuously charging and discharging during driving.

The high voltage battery supplies (discharges) electric energy during the motor assist operation and stores (charges) electric energy during regenerative braking or engine driving. The battery management system (BMS) transmits the battery state of charge (SOC), available charge power, available discharge power, etc., to the HCU/MCU to perform safety and lifespan management of the battery.

A typical vehicle brake unit of a vehicle is configured such that when a driver steps on a brake pedal, the pressure applied to the brake pedal is amplified by a brake booster, and the pressure then generates a hydraulic force so that a mechanism for braking the wheels is operated by the hydraulic force.

The brake booster uses a negative pressure of an intake manifold when the brake pedal is stepped on. As such, it is required to create a vacuum state in the intake manifold, the brake booster, and an intake system connection line through which the supply of the negative pressure is effected between the intake manifold and the brake booster. To this end, a throttle valve needs to be closed.

In a hybrid electric vehicle, the negative pressure of the brake may drop sharply due to an Atkinson cycle (a high-efficiency cycle), CVT load, alternate load, etc. Thus, when the throttle valve is closed, the engine torque is reduced but the pressure of the intake manifold 13 is decreased so that the negative pressure of the brake can be prevented from dropping below a target negative pressure. Also, a decrease in the engine power caused by the closing of the throttle valve is compensated for through a motor torque assist.

When the throttle valve is opened, the pressure of the intake manifold increases (atmospheric pressure is created by the opening of the throttle valve) so as to cause the brake not to work well. Particularly, in cases where the motor assist operation is not performed due to absence of the motor battery, the motor has failed, or the motor assist operation is small due to a deterioration of the motor, the vehicle torque is not generated, or fluctuates. More particularly, in cases where the pressure generating time is lengthened during high-speed driving, brake locking occurs.

The information disclosed in this background of the invention section is only for enhancement of understanding of the background of the invention and should not be taken as an acknowledgement or any form of suggestion that this information forms the prior art that is already known to a person skilled in the art.

### SUMMARY OF THE INVENTION

A fail-safe system for a brake of a hybrid electric vehicle includes: a connection tube for providing fluid communication between an intake system and a brake booster, a vacuum pressure supply element for supplying a negative pressure to the brake booster through, the connection tube, a first valve for interrupting the fluid communication between the intake system and the brake booster, and a control unit for determining a brake fail condition. If the brake fail condition is determined, the control unit controls the first valve to interrupt the fluid communication, and controls the vacuum pressure supply element to supply the negative pressure to the brake booster.

The vacuum pressure supply element may include a vacuum pump mounted at the connection tube and a second valve mounted at the connection tube for opening and closing a passageway of the connection tube.

The system may further include a vacuum holder mounted at the connection tube between the second valve and the vacuum pump for creating negative pressure in the connection tube by the vacuum pump, and a third valve mounted at the connection tube between the vacuum pump and the vacuum holder to open and close the passageway of the connection tube.

The system may further include a negative pressure sensor mounted at the vacuum holder. When the control unit receives a signal from the negative pressure sensor and determines that the negative pressure inside the vacuum holder is below a predetermined level, the control unit controls the vacuum pump to turn on.

A method of controlling a fail-safe system for a brake of a hybrid electric vehicle includes (a) determining whether or not a vehicle state is in a brake fail condition along with turning on of a brake by a user; (b) if it is determined that the vehicle state is in the brake fail condition and the brake is turned on, closing a first valve to intercept pressure supplied from an intake system to a brake booster; (c) operating a vacuum pressure supply element to supply a vacuum pressure to the brake booster, and opening a second valve to allow the brake booster to be maintained in a vacuum state by the vacuum pressure supplied from the vacuum pressure supply element; and (d) closing the second valve, stopping the operation of the vacuum pressure supply element, and opening the first valve upon turning off of the brake by the user.

Step (a) may include determining that the vehicle state is in the brake fail condition if the vehicle is in a high-speed hard braking state, an idle speed control is in a full duty state, and a vehicle speed is over a reference speed.

Step (a) may include determining that the vehicle state is in the brake fail condition if the pressure created by the intake system is higher than a predetermined pressure, the motor is in a fail state, a motor assist operation is impossible, and a battery voltage is lower than a reference voltage.

Step (c) may include operating a vacuum pump of the vacuum pressure supply element and opening a third valve mounted at the connection tube together with the second valve.

Step (d) may include closing the second valve and the third valve, and stopping the vacuum pump.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1 and 2 are schematic views of a fail-safe system for a brake of a hybrid electric vehicle according to embodiments of the present invention, wherein FIG. 1 shows a state where the inventive fail-safe system is not operated, when a vacuum is normally maintained and FIG. 2 show a state where the fail-safe system is operated when the vacuum is not normally maintained; and

FIG. 3 is a flowchart illustrating the process of performing a fail-safe operation and a fail-safe release operation under a brake fail occurrence condition.

Reference numerals set forth in the drawings includes reference to the following elements as further discussed below:
1: brake pedal
2: brake booster
3: master cylinder
11: intake system
12: throttle valve
13: intake manifold
14: intake system connection line
15: negative pressure sensor
20: ECU
21: first pressure-interception valve
22: connection tube
23: vacuum pressure supply element
24: vacuum pump
25: vacuum holder
26: second pressure-interception valve
27: third pressure-interception
28: negative pressure sensor

### DETAILED DESCRIPTION OF PREFERRED EMBODIMENTS

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

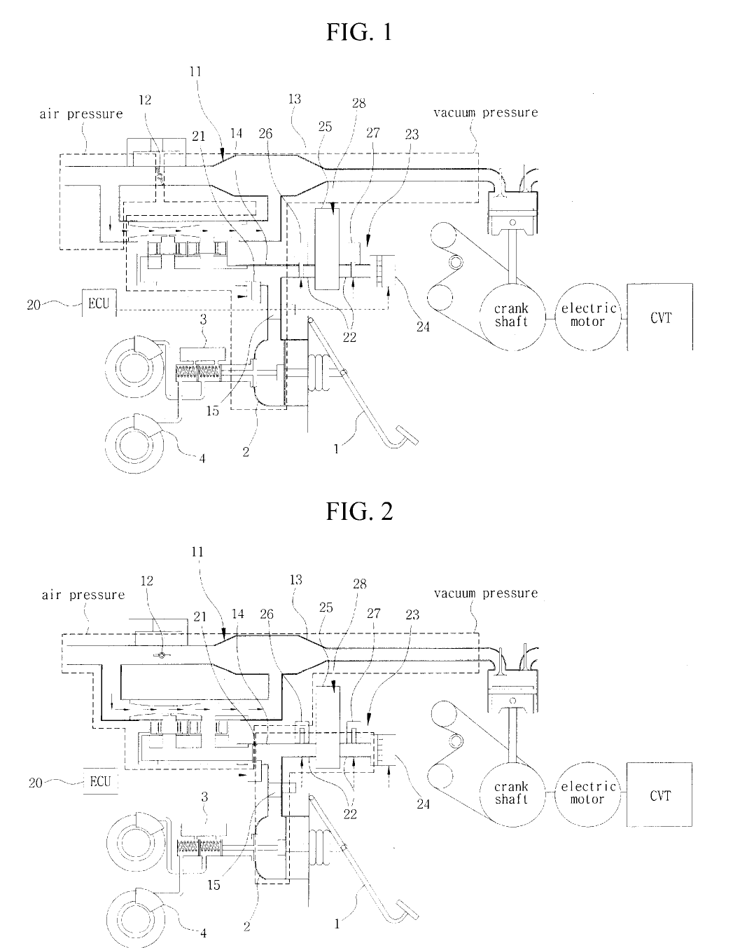

Referring to FIGS. 1 and 2, a connection tube 22 is mounted at an intake system connection line 14 through which a negative pressure is supplied from an intake system 11 to a brake booster 2. A vacuum pressure supply element 23 is mounted at the connection tube 22 so as to independently supply the vacuum pressure to the brake booster 2 through the connection tube 22 and the intake system connection line 14 irrespective of the intake system 22 under the control of an ECU 20.

In addition, a first pressure-interception valve 21 (for example, a solenoid valve) is mounted at the intake system connection line 14. The valve 21 is controlled by the ECU 20.

A preferred embodiment of the vacuum pressure supply element 23 will be described hereinafter.

A vacuum pump 24 is mounted at a distal end of the connection tube 22, and a vacuum holder 25 is mounted at an intermediate portion of the connection tube 22.

Also, a second pressure-interception valve (for example, a solenoid valve) is mounted at the connection tube 22 between the vacuum holder 25 and the intake system connection line 14 so as to open and close a passageway of the connection tube 22, and a third pressure-interception valve 27 is mounted at an intermediate portion of the connection tube 22 between the vacuum pump 24 and the vacuum holder 25 so as to open and close the passageway of the connection tube 22.

The operation of the vacuum pump 24 and the opening and closing of the second and third pressure-interception valves 26 and 27 are controlled by the ECU 20.

Immediately after the driving of the vacuum pump 24 is started in response to the control signal of the ECU 20, it is difficult to supply a vacuum pressure as high as that required by the brake booster 2. Thus, the vacuum holder 25 supplies the vacuum pressure for a certain time immediately after the driving of the vacuum pump 24 is started, so that a necessary vacuum pressure can be supplied to the brake booster 2.

When the vacuum pump 24 is driven and the second and third pressure-interception valves 26 and 27 are opened, the vacuum pressure created by the vacuum pump 24 is supplied to the brake booster 2 while continuously maintaining the vacuum state of the vacuum holder 25.

In addition, although the driving of the vacuum pump 24 is stopped after the second and third pressure-interception valves 26 and 27 are shut off, the vacuum holder 25 continuously maintains a vacuum state since the connection tube 22 is closed by the valves 26 and 27.

As such, when the driving of the vacuum pump 24 is re-started in a fail-safe mode when the vacuum holder 25 maintains a vacuum state in the inside thereof, the vacuum holder 25 temporarily supplies the vacuum pressure to the brake booster 2 until the vacuum pressure is sufficiently supplied by the vacuum pump 24.

Preferably, a separate negative pressure sensor 28 is mounted at the vacuum holder 25 so that an input signal of the negative pressure sensor 28 is received by the ECU 20. If the vacuum pressure inside the vacuum holder 25 drops below a predetermined level during driving of the vehicle, only the second pressure-interception valve 26 is opened temporarily to operate the vacuum pump 24, causing the negative pressure sensor 28 to supplement the vacuum pressure.

Once the vacuum pressure reaches a predetermined level, the ECU 20 closes the second pressure-interception valve 26.

In FIGS. 1 and 2, reference numeral 15 denotes a negative pressure sensor mounted at the intake system connection line 14.

The operation of embodiments of the present invention and a system control process will be described hereinafter.

FIG. 1 shows a state where vacuum pressure is normally maintained in the intake system 11, the intake system connection line 14, and the brake booster 2, in a state where the throttle valve 12 is closed.

In such a state, the second and third pressure-interception valves 26 and 27 are closed, and the vacuum pump 24 is open. A vacuum pressure of a predetermined level the vacuum holder 25 is maintained inside the vacuum holder 25 and the first pressure-interception valve 21 is opened.

In this state, the brake is normally operated by the negative pressure supplied from the intake system 11.

FIG. 2 shows a state where the inventive fail-safe system is operated when the brake is operated under a brake fail condition. In FIG. 2, the throttle valve 12 is opened.

In this state, the operation mode is changed from a normal brake operation mode to a fail-safe mode, i.e., a negative pressure control mode by the vacuum pump 24. In the fail-safe mode, the first pressure-interception valve 21 is closed to interrupt the intake system connection line 14 and drive the vacuum pump 24. Simultaneously, the second and the third pressure-interception valves 26 and 27 are opened to enable the brake booster 2 to temporarily maintain a vacuum state using the vacuum holder 25, and then enable the brake booster 2 and the vacuum holder 25 to maintain a vacuum state by a vacuum pressure created by the motor.

Under the brake fail condition, the ECU 20 controls the fail-safe mode in which the motor is driven, the second and third pressure-interception valves 26 and 27 are opened, and the first pressure-interception valve 21 is closed.

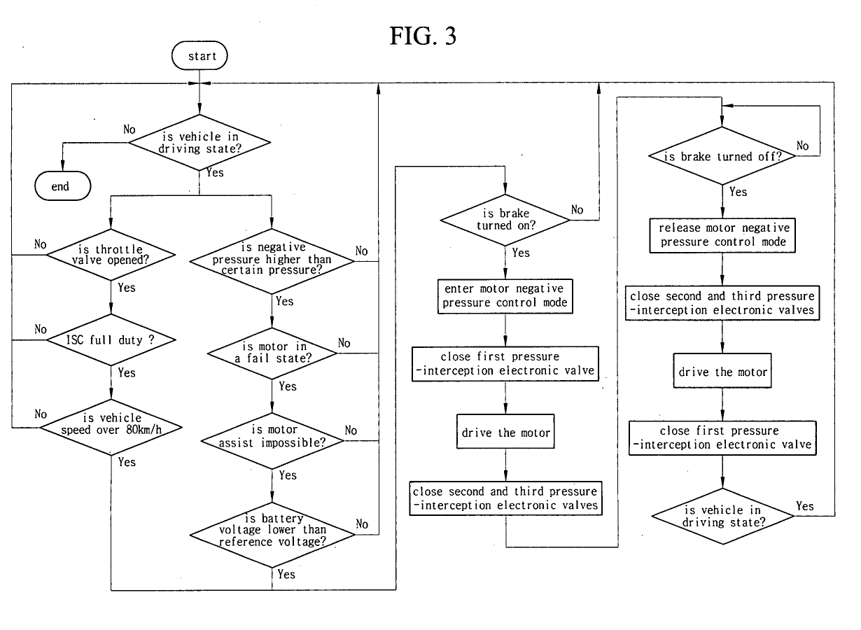

The process of performing a fail-safe operation and a fail-safe release operation will now be described hereinafter with reference to FIG. 3.

The fail-safe operation starts when a driver steps on a brake pedal under the brake fail condition. The fail-safe operation is released when the driver steps off the brake pedal.

First, the ECU 20 determines whether or not the current vehicle state is in a brake fail condition along with the turning on of the brake during driving.

The ECU 20 judges a high-speed hard braking condition and a braking condition in a fail state of an electric motor-related system as brake fail conditions.

In the process of determining the high-speed hard braking condition, the ECU 20 senses if the throttle valve 12 is opened, the idle speed control (ISC) is in a full duty state, and a vehicle speed is over a reference speed during the driving of the vehicle. In this state, when the ECU 20 receives a brake-on signal, it determines that the vehicle is in the high-speed hard braking condition and starts the control of the fail-safe mode.

In the process of determining the braking condition in a fail state of an electric motor-related system, the ECU 20 determines whether or not the negative pressure created by the intake system 11 is higher than a predetermined pressure based on an output signal from the negative pressure sensor 15 during the driving of the vehicle, the motor is in a fail state, a motor assist operation is impossible, and a battery voltage is lower than a reference voltage. In this state, when the ECU 20 receives a brake-on signal, it determines the braking condition in a fail state of an electric motor-related system and starts the control of the fail-safe mode.

If the ECU determined that the vehicle is in a brake fail mode, it changes the normal brake mode to the fail-safe mode, i.e., a negative pressure control mode by the vacuum pump 24. In the fail-safe mode, the first pressure-interception valve 21 is closed to interrupt the intake system connection line 14 and drive the vacuum pump 24. Simultaneously, the second and the third pressure-interception valves 26 and 27 are opened to enable the brake booster 2 to temporarily maintain a vacuum state using the vacuum holder 25, and then enable the brake booster 2 and the vacuum holder 25 to maintain a vacuum state by a vacuum pressure created by the motor.

Thereafter, in a fail-safe mode release condition, i.e., when the ECU 20 receives a brake-off signal, it controls the negative pressure control mode by the vacuum pump 24 to be released to cause the second and third pressure-interception valves 26 and 27 to be closed, the vacuum pump 24 to be closed and the first pressure-interception valve 21 to be opened.

As described above, according to the fail-safe system for a brake of a hybrid electric vehicle and method of controlling the same of embodiments of the present invention, it is possible to interrupt the supply of atmospheric pressure to a brake booster line from an intake system to stably operate a brake under a brake fail condition and operate a separate vacuum supply element, thereby preventing brake failure.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A fail-safe system for a brake of a hybrid electric vehicle, comprising:
a connection tube for providing fluid communication between an intake system and a brake booster;
a vacuum pressure supply element for supplying a negative pressure to the brake booster through the connection tube;
a first valve for interrupting the fluid communication between the intake system and the brake booster; and
a control unit for determining a brake fail condition, and if the brake fail condition is determined, for controlling the first valve to interrupt the fluid communication, and controlling the vacuum pressure supply element to supply the negative pressure to the brake booster.

2. The fail-safe system of claim 1, wherein the vacuum pressure supply element comprises:
a vacuum pump mounted at the connection tube; and
a second valve mounted at the connection tube for opening and closing a passageway of the connection tube.

3. The fail-safe system of claim 2, further comprising:
a vacuum holder mounted at the connection tube between the second valve and the vacuum pump for creating negative pressure in the connection tube by the vacuum pump; and
a third valve mounted at the connection tube between the vacuum pump and the vacuum holder to open and close the passageway of the connection tube.

4. The fail-safe system of claim 3, further comprising a negative pressure sensor mounted at the vacuum holder, wherein when the control unit receives a signal from the negative pressure sensor and determines that the negative pressure inside the vacuum holder is below a predetermined level, the control unit controls the vacuum pump to turn on.

5. A method of controlling a fail-safe system for a brake of a hybrid electric vehicle, comprising:
(a) determining whether or not a vehicle state is in a brake fail condition along with turning on of a brake by a user;
(b) if it is determined that the vehicle state is in the brake fail condition and the brake is turned on, closing a first valve to intercept pressure supplied from an intake system to a brake booster;
(c) operating a vacuum pressure supply element to supply a vacuum pressure to the brake booster, and opening a second valve to allow the brake booster to be maintained in a vacuum state by the vacuum pressure supplied from the vacuum pressure supply element; and
(d) closing the second valve, stopping the operation of the vacuum pressure supply element, and opening the first valve upon turning off of the brake by the user.

6. The method of claim 5, wherein step (a) comprises determining that the vehicle state is in the brake fail condition if the vehicle is in a high-speed hard braking state, an idle speed control is in a full duty state, and a vehicle speed is over a reference speed.

7. The method of claim 5, wherein step (a) comprises determining that the vehicle state is in the brake fail condition if the pressure created by the intake system is higher than a predetermined pressure, the motor is in a fail state, a motor assist operation is impossible, and a battery voltage is lower than a reference voltage.

8. The method of claim 5, wherein step (c) comprises operating a vacuum pump of the vacuum pressure supply element and opening a third valve mounted at the connection tube together with the second valve.

9. The method of claim 8, wherein step (d) comprises closing the second valve and the third valve, and stopping the vacuum pump.
